(19) United States
(12) Patent Application Publication
(10) Pub. No.: US 2007/0060002 A1
(43) Pub. Date: Mar. 15, 2007

(54) Electroconductive textiles

(75) Inventors: Barry Victor Holcombe, Dee Why (AU); Peter John Waters, Mulgrave (AU); Mark Graham Looney, Brunswick (AU); David George Looney, Brunswick (AU); David George King, Barwon Heads (AU); Gordon George Wallace, Gwynneville (AU); Peter Charles Innis, West Wollongong (AU); Syed Aziz Ashraf, Tarrawanna (AU)

Correspondence Address: MERCHANT & GOULD PC, P.O. BOX 2903, MINNEAPOLIS, MN, 55402-0903, US

(73) Assignees: COMMONWEALTH SCIENTIFIC AND INDUSTRIAL, Campbell (AU); UNIVERSITY OF WOLLONGONG, North Wollongong (AU)

(21) Appl. No.: 10/562,844

(22) PCT Filed: Jun. 28, 2004
(86) PCT No.: PCT/AU04/00860

§ 371 Date: Jun. 7, 2006

(30) Foreign Application Priority Data
Jul. 3, 2003 (AU) 2003903431

(51) Int. Cl. B32B 27/04

(52) U.S. Cl. 442/115

(57) ABSTRACT

An electroconductive textile comprising: a non-conductive textile such as a wool-containing fabric, a macromolecular template which is bonded to or entrapped in the non-conductive textile such as poly 2-methoxyaniline-5-sulfonic acid (PMAS), and a conductive polymer which is ordered by and bonded to the macromolecular template such as polyaniline; in which the macromolecular template binds the conductive polymer to the non-conductive textile.

### FIELD OF THE INVENTION

The present invention relates to electroconductive textiles and methods for producing electroconductive textiles.

### BACKGROUND OF THE INVENTION

It has been recognized for some time that the electrical properties of inherently conductive polymers (ICPs) can best be exploited by their incorporation into host structures that provide the required mechanical and physical properties for a given application. Textiles produced from both naturally occurring and synthetic fibres are suited to this purpose.

Inherently conductive polymers immobilised by a textile substrate could be used for a number of applications. These electroconductive textiles can be used in the production of clothing articles which function as wearable strain gauges for use in biomechanical monitoring, or direct biofeedback devices for sports training and rehabilitation. In these articles physical changes in the textile cause changes to electrical resistance or electrical conductivity which can then be monitored. Other applications include the production of clothing articles which change their thermal insulation or moisture transport characteristics in response to changing climatic conditions. Electroconductive textiles can also be used in applications where antistatic or EMI shielding properties are required. A further application is for use in heating devices such as car seats, car seat covers and gloves.

Currently known textile materials coated with inherently conductive polymers suffer from a number of disadvantages.

Ideally, electroconductive textiles should contain electronic components seamlessly integrated into the conventional textile structure, exhibit stable electrical properties, withstand normal wear, and be launderable. There are currently no commercially available conducting polymer coated textiles that fulfil all of these requirements. It would also be desirable for conventional textile dyeing or printing techniques to be used in the production of the electroconductive textile, however this is usually not possible due to the poor solubility properties of the inherently conductive polymers and some monomer precursors in water.

One current method used for preparing electroconductive textiles involves in situ polymerisation of the inherently conducting polymer onto a substantially non-conductive textile substrate. However, there is no apparent bonding between the non-conductive textile and the inherently conductive polymer (including some monomer precursors from which the polymer is formed). Consequently, the polymers can be easily abraded or displaced from the textile, or during laundering the textile may suffer from rapid loss of conductivity. In addition, the polymer component of the electroconductive textile can easily change oxidation state or be dedoped. Moreover, the polymer coating containing the conductive material can significantly change the properties of the non-conductive textile to which it is applied.

For similar reasons, the use of curing agents to affix conductive polymers onto the surface of textile substrates is also disadvantageous.

Another technique currently used for the production of an electroconductive textile involves making the textile fibres from the conductive polymer itself and forming a fabric from the fibres. However, the nature of conductive polymers is such that the fibres are relatively brittle and inextensible and textiles formed from these fibres also suffer from these limitations. In addition, since the conductive polymer component of an electroconductive textile is much more expensive than non-conductive textiles such as cotton, wool and nylon, the electroconductive textile produced by this method is prohibitively expensive.

Another technique explored more recently has involved the polymerisation of conducting polymers onto the chemically activated surface of a textile material. This requires actual pre-phosphonylation of the textile material (such as polyethylene) to create a chemically activated textile which will bond with the conductive polymer. Although this gives rise to a strong bond between the textile and the inherently conductive polymer, phosphonylation changes the feel or “hand” of the textile.

The existing methods also suffer from the fact that there are limited means besides altering the level of doping to control the conductivity of the electroconductive textile.

Another problem associated with the current systems for producing electroconductive textiles relates to the nature of the inherently conductive polymers themselves. A large proportion of known inherently conductive polymers are insoluble in solvents, particularly water. This makes it very difficult to bring the conductive polymers into intimate contact with the textile.

Accordingly, it is an object of the present invention to provide a new approach for the production of electroconductive textiles that address these problems.

### SUMMARY OF INVENTION

According to the present invention there is provided an electroconductive textile comprising:
a non-conductive textile,
a macromolecular template which is bonded to or entrapped in the non-conductive textile, and
a conductive polymer which is ordered by and bonded to the macromolecular template;

such that the macromolecular template binds the conductive polymer to the non-conductive textile.

By using a macromolecular template of a type that is capable of directly binding to or being directly entrapped within the non-conductive textile (i.e. not by affixing with an interposed curing agent), a number of advantages are achieved. Firstly, the macromolecular template will improve the conductive nature of the conductive polymer by inducing order in the conductive polymer. In addition, the macromolecular template and the reaction conditions for directly coupling the macromolecular template to the conductive polymer can be chosen to control the level of conductivity of the conductive polymer.

Another advantage of using a macromolecular template is that a suitable preformed templated conducting polymer can be prepared that will make the conductive polymer soluble in the desired solvent, so as to facilitate the bringing of the conductive polymer into contact with the non-conductive textile. Similarly, a mixture of the macromolecular template with the subunits from which the conducting polymer is made enables solubilization of the subunits in the desired solvent so as to facilitate the bringing of the conductive polymer into contact with the non-conductive textile. This allows for conducting polymers to be applied to textiles using techniques that were otherwise not possible, and without the need for a curing step to bind the conducting polymer to the textile. Various other advantages associated with the use of the macromolecular template will be explained in further detail below.

According to the present invention there is also provided a method for preparing an electroconductive textile from a non-conductive textile and polymer subunits which, when polymerised, form a conductive polymer, the method comprising the steps of:

(i) polymerising the polymer subunits in the presence of a macromolecular template to form the conductive polymer bound to the macromolecular template; and

(ii) contacting the macromolecular template with the non-conductive textile to effect bonding of the macromolecular template to the non-conductive textile.

As will be explained in further detail below with reference to the main alternative techniques for preparing the electroconductive textile, step (ii) outlined above can be conducted prior to, or following step (i). Consequently, the applicant envisages three main methods by which the electroconductive textile can be prepared.

The first alternative method for preparing the electroconductive textile comprises the steps of:

(a) contacting the macromolecular template with the non-conductive textile to effect bonding of the macromolecular template to the non-conductive textile, and

(b) contacting the polymer subunits with the macromolecular template bound to the non-conductive textile, and polymerising the polymer subunits to form the conductive polymer bound to the macromolecular template and to the non-conductive textile via the macromolecular template.

The second alternative method for preparing the electroconductive textile comprises the steps of:

(a) contacting the non-conductive textile, the macromolecular template and the polymer subunits with one another to effect bonding of the macromolecular template to the non-conductive textile, and bonding of the macromolecular template to the polymer subunits, and

(b) polymerising the polymer subunits to form the conductive polymer which is bound to the non-conductive textile via the macromolecular template.

The third alternative method for preparing the electroconductive textile comprises the steps of:

(a) contacting the macromolecular template with the polymer subunits and polymerising the polymer subunits to form the conductive polymer bound to the macromolecular template, and

(b) contacting the macromolecular template with the non-conductive textile to effect bonding of the macromolecular template to the non-conductive textile, with the conductive polymer bound to the non-conductive textile via the macromolecular template.

According to the present invention there is also provided a new use of a macromolecular template having properties which makes it capable of binding with a non-conductive textile, in the preparation of an electroconductive textile from the non-conductive textile and polymer subunits which, when polymerised, form a conductive polymer.

### BRIEF DESCRIPTION OF THE DRAWINGS

The invention is described further by way of example with reference to the accompanying drawings in which:

FIG. 1 illustrates schematically the three main techniques for forming the electroconductive textile of the present invention; and

FIG. 2 is a UV/VIS Spectrum of PMAS and templated PMAS/PAn treated wool/nylon/Lycra®.

### DETAILED DESCRIPTION OF THE INVENTION

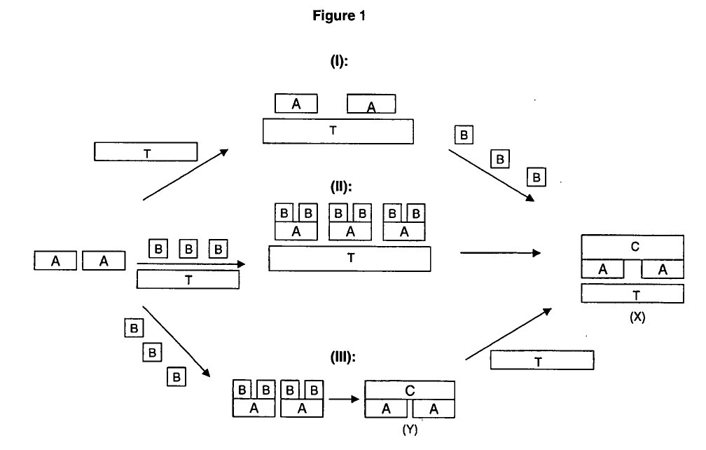

As explained above, there are three main techniques for forming the electroconductive textile of the present invention. These are schematically illustrated in FIG. 1.

The first alternative method represented by (I) involves applying the macromolecular template represented by A to the textile, represented by T. In a second step the polymer sub-units represented by B are brought into contact with the macromolecular template A bound to the non-conductive textile T, and polymerisation is effected while in situ in the textile to produce the electroconductive polymer C. The final product, which may need to be subjected to further treatment steps such as doping, is the electroconductive textile X.

The second alternative method for preparing the electroconductive textile X is represented by (II). According to this method, the macromolecular template A is contacted with the polymer subunits B, prior to or at the same time that it is contacted with the textile T. This will yield a treated non-conducting textile T containing the macromolecular template A and polymer subunits B. In a second stage, polymerisation of the subunits B is effected to produce the electroconductive polymer C and thus yield the electroconductive textile X.

The third alternative method for preparing the electroconductive textile X is represented by (III). According to this method, the macromolecular template A is brought into contact with the polymer subunits B, which are then polymerised to yield a preformed templated conductive polymer as represented by Y. The preformed templated polymer Y is then applied to the textile to yield the electroconductive textile X.

It is to be understood that the macromolecular template A and the polymer subunits B may constituted by mixtures of different materials.

In the following we have explained the meaning of the various terms used in the specification for complete understanding of the scope of the invention.

Non-Conductive Textile Material

The term “textile material” or “textile” is used herein in its broadest sense and includes yarns, threads, fibres, cords, filaments, fabrics, cloths and materials that have been woven, knitted, felted, thermally bonded, hydroentangled, spunbonded, meltblown, electrospun or formed from other nonwoven processes or formed from the foregoing, and combinations thereof.

The term “non-conductive” means that the textile material is non-conductive, or has very low conductivity. Non-conductive is defined as having a surface resistivity of greater than 10¹¹ Ω/□. Conductivity is the converse of resistivity, which is measured in the art in units of ohms per square (Ω/□).

The textile material may be formed from natural or synthetic fibres or a combination of the two. Natural fibres include, notably, cellulosic fibres and proteinaceous fibres, such as cotton, hemp and wool. Synthetic fibres include the range of polymers that have been made in a fibre form, including polyalkylenes (and homopolymers or copolymers; examples of the homopolymers being polyacrylonitrile and polypropylene); polyamides including nylon (such as nylon 6 and nylon 66), Kevlar® and Nomex®; polyurethanes, including polyurethane block copolymers (such as Lycra®); polyureas (and block copolymers thereof such as polyurethaneureas); polyesters such as polyethylene terepthalate (PET); and synthetic cellulose-derived fibres, such as rayon, and combinations thereof.

According to one embodiment, the non-conductive textile is a natural fibre-containing textile, suitably a wool-containing textile.

Due to the choice of templates and conductive polymers used, the non-conductive textiles do not need to be subjected to a functionalization reaction (sometimes required in the art) for fixation purposes. Thus, according to one embodiment, the non-conductive textiles used in the present invention are not subjected to a functionalization reaction to make it possible for a covalent bond to be formed between the textile and the macromolecular template on later application of the macromolecular template. Preferably, the non-conductive textile also contains no phosphonylation.

Similarly, the textiles can be made electroconductive by techniques that do not require a curing step to bind the conducting polymer to the textile. This is also an advantage of the present invention.

Conductive Polymer

The term “conductive polymer” is used broadly to refer to any of the class of conductive polymers known in the art. These are sometimes referred to as “inherently conductive polymers” or “intrinsically conductive polymers”.

Conductive polymers are unsaturated polymers containing delocalised electrons and an electrical charge. Conductive polymers may be positively or negatively charged (cationic or anionic), and are associated with counter ions referred to as the dopant. Polymers in the main class of conductive polymers are polymerised from their polymer subunits by oxidation. These will be referred to as the oxidatively polymerised conductive polymers.

The term “conductive polymer” is used in its broadest sense to refer to doped and dedoped conductive polymers, and therefore it encompasses any of the polymers which form polaronic (including bipolaronic) moieties. Generally, polarons are the charge carrying species which are generated by the oxidation of the conjugated polymer backbone.

Examples of suitable conductive polymers are polypyrrole and its derivatives, polythiophene and its derivatives, phenyl mercaptan and its derivatives, polycarbazole and its derivatives, polyindole and its derivatives and polyaniline and its derivatives, or combinations thereof. Suitable derivatives are those that contain functional groups, such as a methoxy group. Examples within the range of other optional functional groups are alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitroalkyl, nitroalkenyl, nitroalkynyl, nitroaryl, nitroheterocyclyl, amino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulfonyloxy, arylsulfenyloxy, heterocyclyl, heterocycloxy, heterocyclamino, haloheterocyclyl, alkylsulfenyl, arylsulfenyl, carboalkoxy, carboaryloxy, mercapto, alkylthio, benzylthio, acylthio, sulfonate, carboxylate, phosphonate and nitrate groups or combinations thereof. The hydrocarbon groups referred to in the above list are preferably 10 carbon atoms or less in length, and can be straight chained, branched or cyclic.

Dopant

Dopants or doping agents provide the counter ions which are associated with the conductive polymers. These may be derived from strong acids such as p-toluene sulfonic acid, naphthalene disulfonic acid, methane sulfonic acid, chloromethyl sulfonic acid, fluoromethyl sulfonic acid, oxalic acid, sulfosalicylic acid and trifluoroacetic acid. However, as explained below, the dopant may be provided by the macromolecular template or another agent (for example, the acid moiety of the functional groups present in any reagent used in forming the electroconductive textile). Oxidizing agents such as ammonium persulfate, ammonium peroxydisulfate, iron (III) chloride, salts of permanganates, peracetates, chromates and dichromates may contribute to the doping effect.

Polymer Sub-units

The term “polymer sub-unit” is used herein to refer to monomers, dimers, multimers (eg oligomers) and mixtures thereof that, upon polymerisation, form a polymer. In the context, the polymer formed may be a conductive polymer. The polymer subunits which form the conductive polymer may be the same or different. Furthermore, the dimer and multimer may be formed from monomer units which are the same or different. Consequently, the conductive polymer may be a homopolymer or a copolymer.

Examples of suitable polymer sub-units are aniline, thiophene, bithiophene, terthiophene, pyrrole, phenyl mercaptan, indole, carbazole, and derivatives thereof. Pyrrole, thiophene and aniline and their derivatives are particularly preferred.

Polymer

The term “polymer” is used in its broadest sense to encompass homopolymers, copolymers, oligomers and so forth, unless the context is to the contrary.

Macromolecular template

The term “molecular template” refers to any chemical, compound, substance or mixture thereof that provides a template upon which, or in relation to which, the polymer subunits of the conductive polymer will preferentially align to induce the desired orientation of the subunits for forming the conductive polymer. For instance, where the polymer is to be preferentially para-directed during synthesis, an appropriate template is one which causes the polymer subunits to be aligned to form a complex with the template that leads to mostly para-directed synthesis, with limited alternative branching. The prefix “macro” means that the molecular template is a macromolecule in size. A macromolecule is defined as a molecule of high relative molecular mass, the structure of which essentially comprises the multiple repetition of units derived, actually or conceptually, from the molecules of low relative molecular mass. To avoid any doubt, we note that porphyrins, large dyestuffs and similar compounds are encompassed by the expression “macromolecule”. Generally, macromolecules have a molecular weight of about 1000 or more, suitably 1200 or more. The term “macromolecular template” encompasses polymeric molecular templates, and indeed particular embodiments of the invention utilise polymeric molecular templates.

Although a large range of substances are known to function as “molecular templates” in a broad sense, it is noted that the macromolecular templates of the present invention must be compounds that are capable of bonding with or being entrapped within the non-conductive textile. Consequently, not all materials described in the prior art as molecular templates function as macromolecular templates as defined in the present application.

The templates of the present invention are “molecular” in that they provide template-guiding on a molecular level, rather than a physical level.

The macromolecular templates provide strands or a structured surface area upon which the polymer subunits that form the conductive polymer can be bound in an ordered fashion by non-covalent intermolecular interactions to form a stable molecular complex.

The macromolecular templates may be non-conductive or conductive. The use of conductive macromolecular templates is of particular interest, as they can add to the conductive properties of the electroconductive textile themselves.

Electrically conductive macromolecular templates, and particularly polymeric molecular templates, encompass conductive polymers containing one or more acid, ester or salt (electrolyte) groups, and derivatives thereof. The acid or ester group is one that contains a carbon, sulfur, nitrogen or phosphorous to oxygen double bond, and a single bond from said carbon, sulfur, nitrogen or phosphorous atom to another oxygen (or sulfur or nitrogen) atom. Accordingly, this class of functional groups includes sulfates, sulfonates, carboxylates, phosphonates, nitrates, amides, and the acid equivalents (such as sulfonic acid, carboxylic acid, and so forth) and derivatives thereof. Sulfonate and sulfate groups are preferred. Such conductive macromolecular templates containing sulfonate and/or sulfate may be fully or partially sulfonated.

These conductive polymers may contain any other functional groups, such as a methoxy group. Examples within the range of other optional functional groups are alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitroalkyl, nitroalkenyl, nitroalkynyl, nitroaryl, nitroheterocyclyl, amino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulfonyloxy, arylsulfenyloxy, heterocyclyl, heterocycloxy, heterocyclamino, haloheterocyclyl, alkylsulfenyl, arylsulfenyl, carboalkoxy, carboaryloxy, mercapto, alkylthio, benzylthio and acylthio. The hydrocarbon groups referred to in the above list are preferably 10 carbon atoms or less in length, and can be straight chained, branched or cyclic.

A preferred class of conductive macromolecular templates encompasses the sulfonated polyanilines, sulfonated polypyrroles, and sulfonated polythiophenes, and derivatives thereof. The expression “derivatives thereof” means that the compounds contain one or more of the functional groups outlined above. One particularly useful molecular template within this class is poly 2-methoxyaniline-5-sulfonic acid (PMAS).

Examples of non-conductive macromolecular templates which can be used are polyvinylsulfonate, polystyrene sulfonates, biologically active polymers such as heparin, chondroitin sulfate and dextran sulfate, as well as large multicharged ions such as calixarenes, cyclodextrins and selected polymeric textile dyestuffs. Although these compounds are non-conductive, they can provide dual functions. For instance, these compounds function as macromolecular templates, and may also function as a dopant or dye for colouring of the textile.

Thermally sensitive polyelectrolytes such as poly-2-acrylamido-2-methyl propane sulfonic acid (PAMPS) and co-polymers comprising the AMPS monomer are other examples of macromolecular templates which can be used.

Redox containing polyelectrolytes such as polyvinyl ferrocene sulfonate are other examples of macromolecular templates that provide a function in addition to the molecular template function. Other classes of macromolecular templates that provide a dual function comprise UV absorbers, fluorescent whitening agents, stain blocking agents and shrinkproofing polymers which are also macromolecular templates. It is to be noted, however, that not all UV absorbers, fluorescent whitening agents, stain blocking agents and shrinkproofing polymers are or can act as macromolecular templates.

As mentioned above, the macromolecular template may be conductive, and in this instance the macromolecular template can be either a cationic or anionic conductor. Cationic macromolecular templates may be used to bind an anionic conductive polymer to the non-conductive textile. Similarly, an anionic macromolecular template may be used to bind a cationic conductive polymer to the non-conductive textile.

Polyelectrolytic molecular templates are the preferred class of macromolecular templates, and an example includes PMAS.

In a preferred embodiment, the macromolecular template can provide an environment for facile oxidation of the polymer subunits to form the conductive polymer.

Bound

The term “bound” or “bonded” or “bind” refers to non-covalent or covalent intermolecular interactions between two compounds. Hydrogen bonding is encompassed by this term. This term is used in the sense of direct bonding between two compounds without an interposed agent such as a curable adhesive. Covalent bonding refers to the direct interaction between the macromolecular template and the textile, or the macromolecular template and the conducting polymer. Non-covalent bonding encompasses ionic intermolecular interactions sufficient to bond one surface directly to the other without any interposed agent such as an adhesive.

One test for determining whether the conductive polymer is bound to the non-conductive textile via the macromolecular template only as required herein involves subjecting the product to sonication to detect evidence of loss of the conductive polymer from the textile. Removal of conductive polymer during the sonication test indicates that the conductive polymer is not bound by the intermolecular interactions. Another simple test correlates to the standard test used in fabric dyeing to determine whether a colouring agent has bonded to the fabric or not. This involves rubbing the textile against white fabric. Marking of the white fabric demonstrates that the dye has not bonded to the fabric.

In the non-printing methods for applying the conductive polymer to the non-conductive textile, the mechanism of binding is preferably not a curing mechanism.

Entrapment

The expression “entrapped in” refers to the situation where the macromolecular template forms an interpenetrating network through the textile fibre matrix. The expression “interpenetrating network” is well understood in the field of polymers and is used in the same sense here. It involves the polymer chains extending into the textile fibre matrix and being entrapped therein without direct covalent chemical bonding.

Polymerisation

The polymer sub-units are polymerised by any process appropriate for the particular monomers involved. This encompasses addition polymerisation or condensation polymerisation, with free radical initiation, where required, produced by redox reaction, light or microwave. Usually the polymerisation is by way of addition polymerisation for the production of the conductive polymer.

The contacting of the various components with one another in the methods of the invention can be achieved by any appropriate technique. Advantageously this is achieved by one of the conventional textile dyeing techniques, including padding, exhaustion, printing and coating including foam applications.

Products Made from Electroconductive Textiles

The electroconductive textiles of the present invention may be used to manufacture articles requiring electroconductive properties. The articles may be made partly or entirely from the electroconductive textile. Examples include gloves, car seats, heating panels for car seats, protective clothing, hosiery, and other apparel items, footwear, headgear, strain gauges, energy storage devices such as batteries or capacitors, and energy conversion devices.

The present invention provides additional functionality, and overcomes compatibility issues of some conductive polymers with non-conductive textiles when the prior art is employed. The present invention also provides a means of locating the conductive polymer either inside the non-conductive textile or on its surface, thereby allowing users to further tailor electroconductive textiles to suit individual applications and requirements.

Other Product and Process Options

As indicated above, the macromolecular template can itself be a conductive polymer. In this situation, the electroconductive textile comprises a non-conductive textile, having a conductive macromolecular template bonded thereto, and a conductive polymer (which may be the same substance or a different substance to the macromolecular template) bonded thereto. It is also possible, according to this embodiment or any other embodiment, to apply to the 3 component electroconductive textile one or more further layers of conductive polymer.

### EXAMPLES

A number of preferred embodiments are described by reference to the following non-limiting examples.

Most of the examples provided below utilise poly 2-methoxyaniline-5-sulfonic acid (PMAS) as the macromolecular template. This macromolecular template is itself a conductive polymer, and therefore some electrical resistivities are reported for textiles to which the macromolecular template has been applied. However, to avoid misunderstanding, it is noted that not all conductive polymers are capable of functioning as a macromolecular template which both provide the templating function for the conductive polymer, and bond to a non-conductive textile. Nevertheless, as these precursors in the preparation of the electroconductive textiles of the present invention do have conductive properties, their levels of electrical resistivity have been reported on occasion in the following examples.

Furthermore, in the examples, the % exhaustion (for example, of molecular template onto non-conductive textile) was determined from UV/VIS absorption spectroscopy. For PMAS, this was calculated from the 474 nm absorption peak. The measurements were taken at the end of the process step (eg after 4 hours and 30 minutes application time). This is confirmed in the Tables where * is marked.

The values for electrical surface resistivity reported were determined using a modification of the AATCC Test Method 76-1995 Electrical Resistivity of Fabrics, and represent the mean and standard deviation of 3 readings on a single textile treatment. The electrical resistance of the treated fabrics was measured on a measurement rig consisting of 2 copper bars spaced 1.5 cm apart embedded in a Perspex base and 2 copper bars which sat atop the fabric. The textile sample had been conditioned at 20° C. and 65% RH for a period of 2 hours before measurement. After placement of the textile between the copper bars, a 1 kg weight was placed atop the rig, and an electrical resistance measurement was taken after 60 seconds. Electrical resistance values were converted to electrical surface resistivity, and quoted as Ω/□.

1. First Alternative Method for Forming Electroconductive Textile

1.1 Step 1: Application of Macromolecular Templates to Non-Conductive Textiles

In this Section we demonstrate methods for applying the macromolecular template of the preferred embodiment of the invention to a non-conductive textile. Whilst this corresponds directly to the first step of the first alternative method for forming the electroconductive textile of the invention, the same techniques apply to any of the steps of the second and third alternative methods (illustrated in FIG. 1) in which a macromolecular template is contacted with the non-conductive textile, irrespective of whether or not the macromolecular template has already been contacted with the polymer subunits.

1.1.1 Exhaust Application of PMAS onto Wool-based Textiles

PMAS [10% on mass of fabric (omf)] was applied to a scoured chlorine-Hercosett treated wool knit textile using an Ahiba Texomat Laboratory Dyeing Machine with the wool textile being wound onto a spindle and submerged in the application liquor. A liquor:goods ratio of 50:1 was used and the PMAS application was made to 2 g sample of textile which had been wet out prior to use by soaking at room temperature for 10 minutes in 1 g/L Lissapol TN450 (ICI, non-ionic surfactant) followed by a distilled water rinse and a final 10 min soak in acid solution at the desired pH.

The PMAS solution was adjusted to pH 1.4 by the drop-wise addition of 10% w/v H₂SO₄ to the stirred solution. The wool textile was introduced to the application bath at 40° C., heated to 90° C. over 30 minutes, and the temperature maintained for a further 4 hours. The textile sample was then removed from the application liquor and rinsed in cold tap water until no signs of “bleed” were evident. Excess water was removed and the sample was air-dried at room temperature overnight prior to measurement of the electrical resistivity.

This basic process was used for the application of the macromolecular template to the non-conductive textile unless otherwise stated.

1.1.2 Variation of Application pH

The process outlined in 1.1.1 above was repeated with modification of the initial pH of the PMAS application liquor. The results of these trials are demonstrated in Table 1.

TABLE 1

| Initial | Final | Final % PMAS | Textile Electrical |
|---|---|---|---|
| pH | pH | Exhaustion* | Resistivity |
| 2.7 | 4.2 | 50.0 | 454 +/− 59 GΩ/□ |
| 2.0 | 2.5 | 52.7 | 8.3 +/− 0.3 GΩ/□ |
| 1.8 | 2.0 | 60.3 | 1.3 +/− 0.1 GΩ/□ |
| 1.6 | 1.8 | 71.5 | 334 +/− 29 MΩ/□ |
| 1.4 | 1.5 | 86.3 | 160 +/− 11 MΩ/□ |

These trials demonstrate that PMAS uptake is dependent upon the application pH. Lowering the initial pH results in increased uptake of the PMAS and decreased electrical resistivity of the treated textile.

Non-conductive textiles other than wool can be subjected to an application pH of less than pH 1.4 due to better stability of the textile in acid at the process temperatures. Wool non-conductive textiles, however, are preferable treated at pH 1.4 or above. Under these conditions the wool textiles produced were structurally intact, with no obvious weakening of the textile integrity. The coated textiles could be stretched up to 70%, without tearing.

1.1.3 Variation in Application Temperature

The process outlined in 1.1.1 above was repeated with modification of the temperature of the PMAS application liquor. The results of these trials are set out in Table 2.

TABLE 2

| Appl. | | | | Textile |
|---|---|---|---|---|
| Temp. | Initial | Final | Final % PMAS | Electrical |
| (° C.) | pH | pH | Exhaustion* | Resistivity |
| 60 | 1.4 | 1.4 | 38.0 | 14.4 +/− 0.5 GΩ/□ |
| 70 | 1.4 | 1.4 | 38.7 | 2.4 +/− 0.1 GΩ/□ |
| 80 | 1.4 | 1.4 | 51.9 | 410 +/− 21 MΩ/□ |
| 90 | 1.4 | 1.5 | 86.3 | 160 +/− 11 MΩ/□ |
| 100 | 1.4 | 1.5 | 100.0 | 828 +/− 32 MΩ/□ |

Higher application temperatures are preferred for maximising uptake of the macromolecular template, although ultimately the temperature used may be influenced by other factors such as electrical resistivity and textile deterioration.

1.1.4 Variation in Acid Used to Adjust pH

The standard method outlined in 1.1.1 for the uptake of PMAS on wool was repeated with the substitution of the sulfuric acid with other acids. The result of this trial is set out in Table 3.

TABLE 3

| | Initial | Final | Final % PMAS | Textile Electrical |
|---|---|---|---|---|
| Acid | pH | pH | Exhaustion* | Resistivity |
| H₂SO₄ | 1.4 | 1.4 | 96.8 | 227 +/− 13 MΩ/□ |
| HCl | 1.4 | 1.5 | 99.9 | 4.0 +/− 3.2 GΩ/□ |
| p-Toluene | 1.4 | 1.5 | 92.3 | 280 +/− 1 MΩ/□ |
| Sulfonic Acid | | | | |
| 10-Camphor | 1.4 | 1.5 | 87.3 | 176 +/− 1 MΩ/□ |
| Sulfonic | | | | |
| Acid | | | | |

1.1.5 Variation in PMAS Concentration

The process outlined in 1.1.1 above was repeated with modification to the PMAS concentration, measured as a percentage based on the mass of the non-conductive textile. The results of these trials are set out in Table 4.

TABLE 4

| Initial | | | |
|---|---|---|---|
| PMAS Conc. | Final | Final % PMAS | Textile Electrical |
| (% omf)^{&} | pH | Exhaustion* | Resistivity (MΩ/□) |
| 5 | 1.5 | 99.4 | 804 +/− 21 |
| 10 | 1.5 | 71.1 | 88.6 +/− 1.9 |
| 15 | 1.4 | 59.3 | 71.3 +/− 1.1 |
| 20 | 1.4 | 46.9 | 80.9 +/− 1.1 |

^{&}“omf” refers to “on mass of fabric”.

1.1.6 Variation of Macromolecular Template
1.1.6.1 Other Conductive Macromolecular Templates

Other water-soluble conductive templates can be used in place of PMAS. Partially sulfonated polyaniline, with sulfonation on ˜80% on the aniline rings was produced from polyaniline by the method using chlorosulfonic acid. Application of the partially sulfonated polyaniline to scoured chlorine-Hercosett treated wool knit textile was performed using the same conditions described in 1.1.1 for PMAS. This application resulted in an exhaustion of 80.0% of the partially sulfonated polyaniline onto the textile material, affording it an electrical resistivity of 790 +/−13 MΩ/□.

Similarly, PMAS was substituted by water-soluble copolymers of the 2-methoxyaniline-5-sulfonic acid monomer (MAS), and aniline (AN). Copolymers with MAS/AN molar feed mix ratios varying from 19:1 to 4:1 have been prepared and evaluated. They have been found to provide a similar conductive effect to PMAS, with electrical resistivities as low as 35 +/−3 MΩ/□ being recorded for wool knit textile samples prepared from the copolymers by the same conditions for PMAS.

1.1.6.2 Non-conductive Macromolecular Templates

The method outlined in 1.1.1 above was repeated with the replacement of the PMAS with a range of other macromolecular templates applied at 10% offer based on mass of fabric. The results of the exhaustion levels from this study, as determined by UV/VIS, are set out in Table 5 below:

TABLE 5

| Macromolecular Template | % Exhaustion level |
|---|---|
| Basyntan D liquid (BASF) | 80 |
| Seicitan D Liquid (Seici) | 76 |
| Intan EMS (Alpa) | 96 |
| Trupotan R83 (Trumpler) | 42 |
| Synthaprett BAP (Bayer) | 34 |
| Orotan SN Powder (Bayer) | 90 |
| Poly (styrene sulfonic acid/maleic | 75-80 |
| acid) (Polysciences Inc.) | |
| 3:1 or 1:1 | |
| Dextran Sulfate | 97* |

*Exhaustion of dextran sulfate was determined by toluidine blue assay. Similar levels of exhaustion of dextran sulfate were obtained for 20, 30, 40 and 50% offers based on mass of wool fabric

1.1.7 Variation of Non-Conductive Textile.

The process outlined under 1.1.1 above was repeated with the substitution of the wool textile described there with the following textile composites:

wool/nylon/Lycra®;

wool/polyester;

nylon;

nylon/Lycra®; and

cotton.

3 different wool/nylon/Lycra® fabrics were used. They ranged in wool content from 90-97%, nylon 2-8%, and Lycra® 0.5-1%, and were of approximately 270 g/m² density. These fabrics were manufactured by the applicant, and have commercially available equivalents.

The nylon and nylon/Lycra® were commercially available textiles obtained from a retailer of fabrics. The cotton was a scoured fabric that again was knitted by the applicant, having similar properties to commercially available cotton fabric.

The wool-based templated textiles produced had similar electrical resistivity to the 100% wool textiles reported in 1.1.1 above.

1.1.8 Other Application Techniques for PMAS

Examples 1.1.1-1.1.7 all relate to the application of the macromolecular template to the non-conductive textile by the exhaust technique, in which the non-conductive textile is saturated in an application liquid containing the macromolecular template. In the following we have exemplified other application techniques.

1.1.8.1 Padding

An aqueous pad liquor (100 ml) was prepared containing 33.3 g/L PMAS at 20° C. The unadjusted pH of the pad liquor prior to use was 1.2. A 2 g sample of wool textile was wet out prior to being padded by soaking in an aqueous solution of 1 g/L Lissapol TN450 (non-ionic surfactant, ICI) at 20° C. for 10 minutes. The fabric was rinsed at room temperature with distilled water and then passed through squeeze rollers set to provide 100% pickup. The damp fabric was then added to the pad liquor, the fabric allowed to become saturated with the liquor over 2 minutes with mild agitation by hand, then withdrawn and passed through squeeze rollers that provided a pickup of 225%. These conditions had the effect of applying 7.5% omf PMAS to the textile sample. After this treatment, the sample was placed in an airtight plastic bag and “batched” at 20° C. in the dark for 24 hours. Following this period, the sample was removed from the plastic bag and rinsed in cold tap water until free of “bleed”, dried overnight at room temperature and the electrical resistivity of the textiles was then measured to be 870 +/−11 MΩ/□.

1.2 Step 2: Contacting of Templated Textile with Polymer Subunits and In situ Polymerisation

1.2.1 In Situ Polymerisation of Aniline on PMAS Pre-treated Wool Textiles

A sample of the PMAS treated textile of Example 1.1.1 was wound onto a spindle and wet out by soaking at room temperature for 10 min in 1 g/L Lissapol TN450 (ICI, non-ionic surfactant) followed by a distilled water rinse. Aniline was added to distilled water (80 ml) and after stirring for 30 min, the pH was adjusted to pH 1.4 by the drop-wise addition of a 10% w/v solution of sulfuric acid and the final volume was made up to 85 ml.

The spindle was placed in the aniline solution and stirred for 15 min using an overhead stirrer (60 rpm). The in situ polymerisation was brought about by the drop-wise addition of a solution of ammonium persulfate in distilled water (15 ml) over a 15 min period to the mixture, which was then left to stir for a further 16 h at room temperature. After the 16 h, the sample was removed, rinsed in cold water and allowed to air dry at room temperature. A significant decrease in electrical resistivity from 160 MΩ/□ for the PMAS treated wool to 69 KΩ/□ for the templated textile after the in situ polymerisation process was observed.

1.2.2 Variation in PMAS:Aniline Ratio

The method outlined in 1.2.1 above was repeated with modifications to the molar PMAS:aniline ratio. The results are set out in Table 6. The results show that there is an optimum molar ratio of PMAS:aniline of approximately 1:2, at a constant aniline:oxidant ratio of 1:0.25.

TABLE 6

| | | Templated Textile |
|---|---|---|
| PMAS:Aniline | PMAS:Aniline:Oxidant | Electrical Resistivity |
| Ratio | Ratio\hat{ } | (MΩ/□) |
| 1:1 | 1:1:0.25 | 8.0 |
| 1:2 | 1:2:0.5 | 1.9 |
| 1:3 | 1:3:0.75 | 3.4 |

\hat{ }Polymerisation using constant 1:0.25 aniline:ammonium persulfate ratio in each case.

1.2.3 Variation of Aniline:Oxidant Ratio

The method outlined in 1.2.1 above was repeated with modifications to the aniline:oxidant molar ratio, where the PMAS:aniline ratio was held constant at 1:2. The results are set out in Table 7. It was found that the range of ratios between 1:0.25-1:0.5 afforded the lowest electrical resistivity for wool-based textiles.

TABLE 7

| Aniline:Oxidant | PMAS:Aniline:Oxidant | Templated Textile |
|---|---|---|
| Ratio | Ratio | Electrical Resistivity |
| 1:0.125 | 1:2:0.25 | 3.7 +/− 0.3 MΩ/□ |
| 1:0.25 | 1:2:0.5 | 136.2 +/− 0.8 KΩ/□ |
| 1:0.5 | 1:2:1 | 154.6 +/− 16 KΩ/□ |
| 1:1 | 1:2:2 | 2.9 +/− 0.5 MΩ/□ |

1.2.4 Variation in PMAS Concentration

The method outlined in 1.2.1 above was repeated, with the modification that the PMAS treated textiles used were not those of Example 1.1.1, but those of 1.1.5, having a concentration of PMAS (measured as a percentage based on the mass of the non-conductive textile—that is % omf) of 5%, 10%, 15% and 20%. The results are set out in Table 8. Increasing the PMAS concentration from 5-15% omf results in a decrease in the electrical resistivity of templated textiles. However, further increases in PMAS concentration were shown to have only marginal influence.

TABLE 8

| Initial | | PMAS conc. | Templated Textile |
|---|---|---|---|
| PMAS Conc. | Final % PMAS | in Textile | Electrical Resistivity |
| (% omf) | Exhaustion* | (% omf) | (KΩ/□) |
| 5% | 99.4 | 5% | 874 +/− 21 |
| 10% | 71.1 | 7.1% | 126.3 +/− 2.1 |
| 15% | 59.3 | 8.9% | 87 +/− 1.1 |
| 20% | 46.9 | 9.4% | 83 +/− 1.1 |

1.2.5 Variation of Polymerisation Temperature

The method outlined in 1.2.1 above was repeated with modifications to the polymerisation temperature. The results are set out in Table 9. The molecular templated textiles were found to have a lower electrical resistivity when the polymerisation was carried out at ambient temperature.

TABLE 9

| Polymerisation | Templated Textile |
|---|---|
| Temperature (° C.) | Electrical Resistivity |
| 38 | 1.1 +/− 0.1 MΩ/□ |
| 23 | 126.3 +/− 2.1 KΩ/□ |
| 2.3 | 275.0 +/− 18.7 KΩ/□ |

1.2.6 Variation of polymerisation pH

The method outlined in 1.2.1 above was repeated with modifications to the polymerisation pH. The results are set out in Table 10.

TABLE 10

| | | PMAS Treated | |
|---|---|---|---|
| Initial | Final | Textile Resistivity | Templated Textile |
| pH | pH | (MΩ/□) | Electrical Resistivity |
| 4.0 | 2.7 | 79.3 | 2.2 +/− 0.1 MΩ/□ |
| 2.4 | 2.4 | 90.2 | 422 +/− 16 KΩ/□ |
| 1.4 | 1.6 | 76.6 | 262 +/− 21 KΩ/□ |

1.2.7 Variation of Acid Used to Adjust pH of Polymerisation Solution

The method of Example 1.2.1 was repeated with the replacement of the sulfuric acid with hydrochloric acid. The results are set out in Table 11.

TABLE 11

| | Templated Textile |
|---|---|
| Acid | Electrical Resistivity (KΩ/□) |
| H₂SO₄ | 126.3 +/− 2.1 |
| HCl | 558 +/− 5 |

2 Second Alternative Method for Forming Electroconductive Textile

2.1 Contacting of PMAS and Aniline to Wool Textile, and in situ Polymerisation of PMAS/Aniline Pretreated Textiles.

A PMAS/aniline mixture was simultaneously applied to scoured chlorine-Hercosett treated wool knit textile using an Ahiba Texomat Laboratory Dyeing Machine. The wool textile was wound onto a spindle and submerged in the application liquor. The spindle was given constant, steady agitation by the dyeing machine during the course of the application. A standard liquor:goods ratio of 50:1 was used throughout, and the application was made to a 2 g sample of wool which had been wet out prior to use by soaking at room temperature for 10 minutes in 1 g/L Lissapol TN450 (ICI, non-ionic surfactant) followed by a distilled water rinse and a final 10 min soak in acid solution at the desired pH.

The PMAS/aniline mixture solution was adjusted to pH 1.4 by the drop-wise addition of acid (10% w/v H₂SO₄) to the stirred solution. The wool textile was introduced to the application bath at 40° C., heated to 90° C. over 30 minutes, and maintained at this temperature for a further 4 hours. After the completion of the application, the mixture was allowed to cool to room temperature. The in situ polymerisation was brought about by the drop-wise addition of a solution of ammonium persulfate in distilled water (15 ml) over a 15 min period to the mixture, which was then left to stir for a further 16 h at room temperature. After the completion of the application, the textile sample was removed from the application liquor and rinsed in cold tap water until no signs of “bleed” were evident. Excess water was removed and the sample was air-dried at room temperature. The wool textiles prepared using this method had electrical resistivities in the range from 80 KΩ/□to 668 KΩ/□.

3 Third Alternative Method for Forming Electroconductive Textile

3.1 Step 1: Synthesis of Preformed Templated Polymers

A series of templated polymers were prepared in the presence of 0.02M PMAS using different concentrations of aniline, as set out in Table 5. Aniline was added to an aqueous solution of PMAS and the resulting solution's pH of about 5.4 was adjusted to pH 2.0 by the addition of HCl (conc.). The required amount of ammonium persulfate solution to facilitate the polymerisation (set out in Table 12) was added drop-wise at such a rate as to maintain the reaction temperature below 24° C. The thick polymer solution obtained was stirred overnight and then dialysed by using 12 kD dialysis tubing. After dialysis the polymer solution was stirred and heated to about 50° C. to concentrate the polymer, and then left to dry by evaporation in a fume hood. The conductivities of pressed pellets of the templated polymers were then measured, and the results are set out in Table 12. Conductivities of pressed pellets as high as 6.8 S/cm were obtained.

TABLE 12

| | Oxidant | Solid Pellet | |
|---|---|---|---|
| Molecular Templating | Concentration | Conductivity | |
| Concentrations | (NH₄)₂S₂O₈ | (S/cm) | pH |
| PMAS + Aniline | 0.02M | 0.05 | 2.0 |
| (0.02M + 0.02M) | | | |
| PMAS + Aniline | 0.06M | 6.8 | 2.0 |
| (0.02M + 0.06M) | | | |
| PMAS + Aniline | 0.08M | 5.1 | 1.9 |
| (0.02M + 0.08M) | | | |
| PMAS + Aniline | 0.055M | 1.2 | 2.0 |
| (0.02M + 0.05M) | | | |
| PMAS + Aniline | 0.02M | 1.0 | 2.1 |
| (0.02M + 0.037M) | | | |

3.2 Step 2: Application of Preformed Molecular Template to Non-conductive Textile

The PMAS/PAn (polyaniline) preformed template and conductive polymer of Example 3.1 containing PMAS:Aniline:oxidant ratio 0.02M:0.06M:0.06M was applied to scoured chlorine-Hercosett treated wool knit textile using an Ahiba Texomat Laboratory Dyeing Machine. The wool textile was wound onto a spindle and submerged in the application liquor, and the spindle was given constant, steady agitation by the dyeing machine during the course of the application. A standard liquor:goods ratio of 50:1 was used throughout this example, and the application was made to a 2 g sample of textile which had been wet out prior to use by soaking at room temperature for 10 minutes in 1 g/L Lissapol TN450 (ICI, non-ionic surfactant) followed by a distilled water rinse and a final 10 min soak in acid solution at the desired pH.

The PMAS/PAn template solution was adjusted to pH 1.4 by the drop-wise addition of acid (10% w/v H₂SO₄) to the stirred solution. The wool textile was introduced to the application bath at 40° C., heated to 90° C. over 30 minutes, and this temperature maintained for a further 4 hours. After the completion of the application, the textile sample was removed from the application liquor and rinsed in cold tap water until no signs of “bleed” were evident. Excess water was removed and the sample was air-dried at room temperature. The products were found to have electrical resistivity values in the range of 2.7-26.7 MΩ/□.

3.2 Application of Other Preformed Templates

The preformed template, poly(styrenesulfonate)/poly(2,3-dihydrothieno[3,4-b]-1,4-dioxin (PSS/PEDOT) was applied to the scoured chlorine-Hercosett treated wool knit textile. The wool textile was wound onto a spindle and submerged in the application liquor, and the spindle was given constant, steady agitation during the course of the application. A liquor:goods ratio of 60:1 was used and the application was made to a 1 g sample of textile which had been wet prior to use by soaking at room temperature for 10 minutes in 1 g/L Lissapol TN450 (ICI, non-ionic surfactant) followed by a distilled water rinse and a final 10 min soak in acid solution at the desired pH.

The PSS/PEDOT template solution was adjusted to pH 1.4 by the drop-wise addition of acid (10% w/v HCl) to the stirred solution. The wool textile was introduced to the application bath at 40° C., heated to 90° C. over 30 minutes, and this temperature maintained for a further 4 hours. After the completion of the application, the textile sample was removed from the application liquor and rinsed in cold tap water until no signs of ‘bleed” were evident. Excess water was removed and the sample was air-dried at room temperature. The product was found to have an electrical resistivity value of 74.8 +/− 3.2 KΩ/□.

4 Use of Other Macromolecular Templates and Conductive Polymers.

Experiments using Method I (see FIG. 1) where polystyrene sulfonate (PSS) (MWt 70,000) is the macromolecular template showed that this polyelectrolyte can also assist in the incorporation of polyaniline into wool/nylon/Lycra®. Further experiments also with Method I showed that by using PMAS as a template, other conducting polymers could also be incorporated into wool/nylon/Lycra®.

4.1 In situ Polymerization of Other Conducting Polymers onto PMAS Treated Wool Fabrics

4.1.1 Templating of Polypyrrole onto PMAS-treated Wool Fabric

The PMAS/polypyrrole templated fabric was formed by in situ polymerisation of pyrrole using method I to PMAS-treated chlorine-Hercosett wool prepared by the procedure of 1.1.1. (Table 13)

A sample of the PMAS treated textile of Example 1.1.1 was wound onto a spindle and wet out by soaking at room temperature for 10 min in distilled water. Pyrrole was added to distilled water (80 ml) and after stirring for 30 min, the pH was adjusted to pH 1.4 by the drop-wise addition of a 10% w/v solution of sulfuric acid, and the final volume was made up to 85 ml.

The spindle was placed in the pyrrole solution and stirred for 15 min using an overhead stirrer (60 rpm). The in situ polymerisation was brought about by the drop-wise addition of a solution of iron (III) chloride hexahydrate in distilled water (15 ml) over a 5 min period to the mixture, which was then left to stir for a further 3 h at room temperature. After 3 h, the sample was removed, rinsed in cold water and allowed to air dry at room temperature. A significant decrease in electrical resistivity from 160 MΩ/□ for the PMAS treated wool to 69 KΩ/□ for the templated textile after the in situ polymerisation process was observed.

The use of other reagents such as hydrochloric acid, anthraquinone-2-sulfonic acid, 1,5-naphthalene disulfonic acid can be used as a replacement for, or in addition to the sulfuric acid to prepare the PMAS/polypyrrole templated fabrics. Alternatively the polypyrrole can be formed using ammonium persulfate as oxidant.

TABLE 13

| | Templated Textile |
|---|---|
| PMAS:Pyrrole:oxidant | Electrical Resistance (KΩ/□)) |
| 1:2:2 | 46.2 +/− 0.3 |
| 1:4:4 | 5.0 +/− 0.1 |

4.1.2 Templating of Polythiophenes onto PMAS Treated Wool Fabric

The PMAS/poly(3-methylthiophene) template was formed by in situ polymerisation of 3-methylthiophene to PMAS treated chlorine-Hercosett wool (171 +/−4.3 MΩ/□) prepared by the procedure of 1.1.1. The 3-methylthiophene was added to the PMAS treated wool stirred in chloroform under nitrogen. To this mixture was added a solution of iron (III) chloride dispersed in chloroform and the resulting mixture was stirred at 40° C. for 2 h. After the completion of the application, the textile sample was removed from the application liquor and rinsed in cold tap water until no sign of “bleed” was evident. Excess water was removed and the sample was air-dried at room temperature. The product was found to have an electrical resistivity value of 67 +/− 2.7 KΩ/□. The reaction can be carried out using acetonitrile as solvent but an increased level of electrical resistivity was observed (7.7 +/− 0.3 MΩ/□).

4.1.3 In Situ Polymerisation of Aniline on Dextran Sulfate Pre-treated Wool Textiles

A sample of the dextran sulfate (20% omf) treated textile (Table 5) was wound onto a spindle and wet out by soaking at room temperature with Lissapol TN450 (1 g/L, ICI, non-ionic surfactant) followed by a distilled water rinse. Aniline (0.01 M) was added to distilled water and after stirring for 1 h, the pH was adjusted to pH 1.4 with hydrochloric acid.

The spindle was placed in the aniline solution and stirred for 15 min using an overhead stirrer (300 rpm) at 2-3° C. The in situ polymerisation was brought about by the drop-wise addition of a solution of ammonium persulfate (0.0018 M) in distilled water (1 drop/sec) and the reaction left to stir overnight at 2-3° C. After the 17 h, the sample was removed, rinsed in cold water and allowed to air dry at room temperature. The electrical resistivity for the templated textile after the in situ polymerisation process was 134-267 MΩ/□.

4.1.4 In situ Polymerisation of Aniline on other Non-Conductive Macromolecular Treated Wool Textiles.

Several other non-conductive macromolecular template materials were also templated with aniline by the same method and conditions as described above for dextran sulfate. The results of these experiments are shown in Table 14.

TABLE 14

| | Templated Textile |
|---|---|
| Macromolecular Template | Electrical Resistivity (MΩ/□)) |
| α-Cyclodextrin hydrate sulfated | 12.5 |
| sodium salt | |
| β-Cyclodextrin hydrate sulfated | 13.8 |
| sodium salt | |
| 4-Sulfonic Calix[6] arene hydrate | 4.9 |

4.2 Templating using the Macromolecular Template as the Oxidising Agent
4.2.1 Oxidation of Aniline due to the Presence of PMAS Treated Wool.

The polymerisation of aniline was carried out in the presence of a PMAS treated textile prepared by the method in 1.1.1. Irradiations of the treated textile in a solution of aniline at wavelengths of either 300 or 419 nm were conducted. The washed and dried samples were found to have a decrease in electrical resistivity of 50% compared to the original PMAS treated textile.

4.2.2 Oxidation of Pyrrole due to the Presence of PMAS Treated Wool.

To an aqueous solution of pyrrole (140 mg in 200 ml), adjusted to pH 1.4 with a 10% solution of HCl, was added a PMAS treated wool fabric (1.5 g, 53 MΩ/□) and the mixture was allowed to stir at room temperature for 48 h in natural light. The sample was removed, rinsed in cold water and allowed to air dry at room temperature. The electrical resistivity for the partially templated textile was 29 MΩ/□.

5. Physical Characterisation of Molecular Templated Textiles

5.1 UV-VIS Spectral Evidence of Formation of Molecular Template

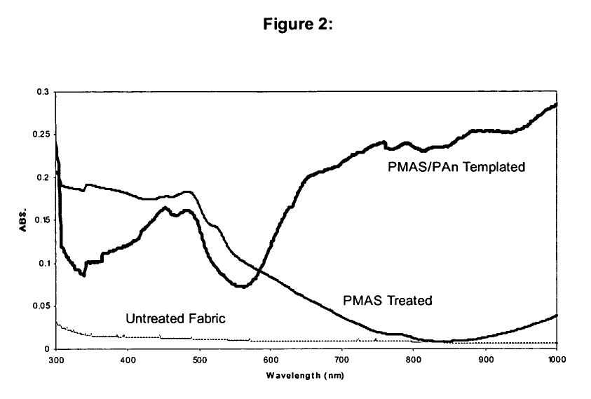

The UV-VIS spectra using 1,2-dichlorobenzene of wool textiles relating to the various stages of the in situ templating process are shown in FIG. 2. The increased adsorption of higher wavelengths of the templated systems is indicative of the formation of the PMAS/PAn molecular template. The figure also demonstrates that the characteristic PMAS band at 474 nm has decreased and absorption around 800 nm typical of polyaniline in the expanded coil form has increased.

5.2 Scotch Tape Test

Each of the electroconductive textile products produced in the Examples outlined above was subjected to the standard scotch tape test to assess bonding of the conductive polymer to the non-conductive textile. Briefly, the test involves adhering commercially available scotch sticking tape to the treated textile, peeling the tape from the treated textile and visually determining whether any polymer has been removed with the tape. All systems evaluated passed the test with no sign of removal of the ICP (see Table 15).

TABLE 15

| Fabric | Scotch tape test |
|---|---|
| PMAS Wool/nylon/Lycra ® | No removal of polymer |
| PMAS/PPy Wool/nylon/Lycra ® | No removal of polymer |
| PMAS/PAn Wool/nylon/Lycra ® | No removal of polymer |
| PPy Wool/nylon/Lycra ® | No removal of polymer |
| Preformed PMAS/PAn Wool/nylon/Lycra ® | No removal of polymer |

5.3 Effect of Washing on Conducting Polymer Treated Textiles

The PMAS/PAn electroconductive textile prepared by Method I (as represented in FIG. 1) was subjected to a standard wash procedure. The test used was a Modified Woolmark Test Method 31, Washing of wool textile products: Standard 7A wash cycle, and was performed in a Wascator FOM 71 MP washing machine. The sample size was 100×100 mm. The results of the washing treatment were compared to a polyaniline and polypyrrole treated textile of the prior art which did not contain the macromolecular template. The results are set out in Table 16.

Table 16 also details the results of an acid treatment conducted on the same textiles. After treatment of the washed samples with aqueous sulfuric acid (pH 1.4), the PMAS/PAn treated textile shows a significant decrease in electrical resistivity whereas the polypyrrole system has increase in electrical resistivity. The polyaniline sample shows no evidence of a decrease in its electrical resistance after the acid treatment.

TABLE 16

| | Polyaniline | | | Polypyrrole |
|---|---|---|---|---|
| | (PAn) | PMAS | PMAS/PAn | (PPY) |
| Starting | 5.6 MΩ/□ | 206 MΩ/□ | 347 KΩ/□ | 11.2 KΩ/□ |
| textile | | | | |
| Washed | >3.2 GΩ/□ | 382 MΩ/□ | 1.35 MΩ/□ | 27.5 KΩ/□ |
| textile* | | | | |
| Acid wash | >3.2 GΩ/□ | 414 MΩ/□ | 811 KΩ/□ | 331 KΩ/□ |

*Modified Woolmark Test Method 31, Washing of wool textile products: Standard 7A wash cycle. Sample size was 100 × 100 mm

5.4 Effect of Rubbing on Conducting Polymer Treated Textiles

The colourfastness to dry rubbing of PMAS/PAn electroconductive textile prepared by Method I (as represented in FIG. 1) was determined in accordance with Australian Standard 2001.4.3—Determination of Colourfastness to Rubbing, using an Atlas Crockmeter. This test involves the dry rubbing of treated textiles using a standard undyed cotton textile (1 M ISO Cotton Rubbing Fabric, supplied by Australian Wool Testing Authority). In addition to the standard 10 rubs required for the test method, extra rubs were performed. This test showed that the PMAS/PAn molecular templated textile had less removal of conducting polymer from the textile due to abrasion than the polyaniline and polypyrrole treated textiles. The alternative molecular templated textile, PMAS/PPY had improved rubfastness compared to the textile treated with only polypyrrole.

TABLE 17

| | Poly- | | | | Poly- |
|---|---|---|---|---|---|
| | aniline | | PMAS/ | PMAS/ | pyrrole |
| | (PAn) | PMAS | PAn | PPY | (PPY) |
| Perpen- | | | | | |
| dicular | | | | | |
| 10 rubs | 4 | 4 | 4 | 4 | 3-4 |
| 20 rubs | 3-4 | 3-4 | 3-4 | 3-4 | 3 |
| 30 rubs | 3 | 3-4 | 3-4 | 3-4 | 2-3 |
| 40 rubs | 3 | 3-4 | 3 | 3-4 | 2-3 |
| Parallel | | | | | |
| 10 rubs | 3-4 | 4-5 | 4 | 4 | 3-4 |
| 20 rubs | 3 | 4 | 3-4 | 4 | 3 |
| 30 rubs | 3 | 3-4 | 3-4 | 3 | 3 |
| 40 rubs | 3 | 3-4 | 3-4 | 3-4 | 3 |

Grey scale ratings 5 to 1 white through to grey. A rating of 5 indicates that no polymer is abraded onto the white cotton test fabric.
6 In Situ Templated Coatings as Wearable Textile Strain Gauges.

The effect on electrical resistance due to the straining of a range of PMAS/PAn molecular templated wool/composite textiles was determined. The dynamic calibrations at frequencies up to 3 Hz and over a range of 10-70% strain showed that the results compared well with those obtained using in situ coated polypyrrole on Nylon/Lycra®. Unlike the polypyrrole-coated materials, minimal change in electrical resistance responses was observed over a three-week period for the PMAS/PAn electroconductive textiles.

It will be understood to persons skilled in the art of the invention that many modifications may be made without departing from the spirit and scope of the invention.

1. An electroconductive textile comprising:
a non-conductive textile,
a macromolecular template which is bonded to or entrapped in the non-conductive textile, and
a conductive polymer which is ordered by and bonded to the macromolecular template; such that the macromolecular template binds the conductive polymer to the non-conductive textile.

2. The electroconductive textile of claim 1, wherein the conductive polymer is an oxidatively polymerised conductive polymer.

3. The electroconductive textile of claim 1, wherein the conductive polymer is selected from polypyrrole and its derivatives, polythiophene and its derivatives, phenyl mercaptan and its derivatives, and polyaniline and its derivatives, polyindole and its deriviates, polycarbazole and its derivatives, or copolymers or combinations thereof.

4. The electroconductive textile of claim 1, wherein the conductive polymer is associated with one or more dopants or doping agents.

5. The electroconductive textile of claim 1, wherein the dopant or doping agent is derived from a strong acid, the macromolecular template or an oxidizing agent.

6. The electroconductive textile of claim 1, wherein the macromolecular template is a conductive macromolecular template.

7. The electroconductive textile claim 6, wherein the conductive macromolecular template is a conductive polymeric molecular template.

8. The electroconductive textile of claim 7, wherein the conductive polymeric molecular template contains one or more acid, ester or salt (electrolyte) groups, or derivatives thereof.

9. The electroconductive textile of claim 7, wherein the conductive polymeric molecular template contains sulfate, sulfonate, carboxylate, phosphonate, nitrate, or amide groups or acid equivalents thereof.

10. The electroconductive textile of claim 7, wherein the conductive polymeric molecular template is sulfonated or sulfated.

11. The electroconductive textile of claim 7, wherein the conductive macromolecular template is selected from sulfonated polyanilines, sulfonated polypyrroles, and sulfonated polythiophenes, and derivatives thereof.

12. The electroconductive textile of claim 11, wherein the conductive polymer molecular template contains one or more functional groups selected from the group consisting of alkyl, alkenyl, alkynyl, aryl, halo, haloalkyl, haloalkenyl, haloalkynyl, haloaryl, hydroxy, alkoxy, alkenyloxy, aryloxy, benzyloxy, haloalkoxy, haloalkenyloxy, haloaryloxy, nitro, nitroalkyl, nitroalkenyl, nitroalkynyl, nitroaryl, nitroheterocyclyl, amino, alkylamino, dialkylamino, alkenylamino, alkynylamino, arylamino, diarylamino, benzylamino, dibenzylamino, acyl, alkenylacyl, alkynylacyl, arylacyl, acylamino, diacylamino, acyloxy, alkylsulfphonyloxy, arylsulfphenyloxy, heterocyclyl, heterocycloxy, heterocyclamino, haloheterocyclyl, alkylsulfphenyl, arylsulfphenyl, carboalkoxy, carboaryloxy, mercapto, alkylthio, benzylthio and acylthio.

13. The electroconductive textile of claim 7, wherein the macromolecular template is poly 2-methoxyaniline-5-sulfonic acid (PMAS).

14. The electroconductive textile of claim 7, wherein the macromolecular template is a cationic macromolecular template and the conductive polymer is an anionic conductive polymer.

15. The electroconductive textile of claim 7 wherein the macromolecular template is an anionic macromolecular template and the conductive polymer is a cationic conductive polymer.

16. The electroconductive textile of claim 1, wherein the macromolecular template is a polyelectrolytic molecular template.

17. The electroconductive textile of claim 1, wherein the macromolecular template provides an environment for facile oxidation of polymer subunits that form the conductive polymer.

18. The electroconductive textile of claim 1, wherein the macromolecular template is non-conductive.

19. The electroconductive textile of claim 18, wherein the macromolecular template is selected from the group of substances consisting of: polyvinylsulfonate, polystyrene sulfonate, biologically active polymers, chondroitin sulfate and dextran sulfate, multicharged ions such as calixarenes, cyclodextrins, polymeric textile dyestuffs thermally sensitive polyelectrolytes, redox containing polyelectrolytes, UV absorbers, fluorescent whitening agents, natural and synthetic tanning agents, lignin and its derivatives, stain blocking agents and shrinkproofing polymers, with the proviso that the substance functions as molecular template by providing a template upon which, or in relation to which, polymer subunits of the conductive polymer preferentially align to induce orientation of the subunits for forming the conductive polymer, and bonds to or is entrapped within the non-conductive textile.

20. The electroconductive textile of claim 1, wherein:
the macromolecular template is selected from the group consisting of sulfonated polyanilines or derivatives thereof, sulfonated polystyrenes or derivatives thereof, dextran sulfate, calixarenes, cyclodextrins and derivatives thereof, synthetic tanning agents based upon sulfonated polycondensation products derived from aromatic sulfonic acids or sulfones and formaldehyde, synthetic tanning agents based upon polyacrylic-acid or salts or esters thereof, polypropylene oxide polyurethane shrinkproofing polymers containing reactive carbamoyl sulfonate groups, sulfonated polypyrroles or derivatives thereof, sulfonated polythiophenes or derivatives thereof, and copolymers or mixtures of any of the above; and
the conductive polymer is selected from the group consisting of polyaniline, polypyrrole, polythiophene, polyphenyl mercaptan polyindole, polycarbazole or derivatives or a copolymer or combination thereof.

21. The electroconductive textile of claim 1, wherein the non-conductive textile contains no functionalization which would enable a reaction forming a covalent bond between the textile and the macromolecular template, and contains no phosphonylation.

22. The electroconductive textile of claim 1, wherein the non-conductive textile is formed from natural or synthetic fibers, or a combination thereof.

23. The electroconductive textile of claim 22, wherein the non-conductive textile contains natural fibres.

24. The electroconductive textile of claim 1, wherein the electroconductive textile contains no curing binder.

25. The electroconductive textile of claim 1, comprising one or more further layers of conductive polymer.

26. A method for preparing an electroconductive textile from a non-conductive textile and polymer subunits which, when polymerised, form a conductive polymer, the method comprising the steps of:
(i) polymerising the polymer subunits in the presence of a macromolecular template to form the conductive polymer bound to the macromolecular template; and
(ii) contacting the macromolecular template with the non-conductive textile to effect bonding of the macromolecular template to the non-conductive textile.

27. The method of claim 26, wherein the macromolecular template is contacted with the non-conductive textile by padding, exhaustion, printing or coating techniques.

28. The method of claim 26, wherein the macromolecular template is applied in an amount of between 0.1 and 50% on mass of fabric.

29. The method of claim 28, wherein the macromolecular template is contacted with the non-conductive textile in an amount of 3-20% on mass of fabric.

30. The method of claim 28, wherein the macromolecular template is applied to the non-conductive textile in an amount of between 5 and 10% on mass of fabric.

31. The method of claim 26, wherein, prior to step (ii), the non-conductive textile is contacted with surfactant.

32. The method of claim 26, wherein step (ii) comprises contacting a solution of the macromolecular template with the non-conductive textile at an initial solution pH of between 1.0-9.0.

33. The method of claim 32, wherein the initial solution pH is between 1.0-2.7.

34. The method of claim 32, wherein the initial solution pH is between 1.4-1.8.

35. The method of claim 26, wherein step (ii) comprises contacting a solution of the macromolecular template with the non-conductive textile at a temperature of between 20 and 130° C.

36. The method of claim 35, wherein step (ii) is conducted by the exhaust technique.

37. The method of claim 36, wherein the contact temperature is between 60 and 100° C., and the time of contact is a period of at least 30 minutes.

38. The method of claim 36, wherein the contact temperature is between 80 and 100° C.

39. The method of claim 37, wherein the time of contact is at least 3 hours.

40. The method of claim 26, wherein step (ii) is conducted by the padding technique.

41. The method of claim 40, wherein step (ii) comprises contacting a padding liquid containing 20-200 grams/litre of the molecular template with the non-conductive textile.

42. The method of claim 41, wherein the pH of the padding liquid is between 1.0-1.8.

43. The method of claim 41, wherein step (ii) effects application of between 5 and 50% of the macromolecular template on mass of the fabric.

44. The method of claim 26, wherein the method comprises the steps of:
(a) contacting the macromolecular template with the non-conductive textile to effect bonding of the macromolecular template to the non-conductive textile, and
(b) contacting the polymer subunits with the macromolecular template bound to the non-conductive textile, and polymerising the polymer subunits to form the conductive polymer bound to the macromolecular template and to the non-conductive textile via the macromolecular template.

45. The method of claim 44, wherein the polymer subunits are polymerised by adding an oxidizing agent.

46. The method of claim 45, wherein the molar ratio of the polymer sub units to the oxidant is between 1:0.16 and 1:0.5.

47. The method of claim 46, wherein a solution of the polymer subunits is contacted with the molecular template bound to the non-conductive textile, and the pH during contacting stage (b) is between 1.1-4.0.

48. The method of claim 47, wherein the pH of contacting step (b) is between 1.1-2.4.

49. The method of claim 47, wherein the pH of the contacting step (b) is between 1.1-1.8.

50. The method of claim 44, wherein the polymer subunits are polymerised at ambient temperature.

51. The method of claim 26, wherein the molar ratio of macromolecular template to the polymer subunits is between 1:1 and 1:40.

52. The method of claim 51, wherein the molar ratio is about 1:2.

53. The method of claim 26, wherein the method comprises the steps of:
(a) contacting the non-conductive textile, the macromolecular template and the polymer subunits with one another to effect bonding of the macromolecular template to the non-conductive textile, and bonding of the macromolecular template to the polymer subunits, and
(b) polymerising the polymer subunits to form the conductive polymer which is bound to the non-conductive textile via the macromolecular template.

54. The method of claim 53, wherein step (a) involves contacting a solution of the macromolecular template and the polymer subunits with the non-conductive textile, and step (b) comprises the addition of an oxidant to the solution containing the non-conductive textile.

55. The method of claim 26, wherein the method comprises the steps of:
(a) contacting the macromolecular template with the polymer subunits and polymerising the polymer subunits to form the conductive polymer bound to the macromolecular template, and
(b) contacting the macromolecular template with the non-conductive textile to effect bonding of the macromolecular template to the non-conductive textile, with the conductive polymer bound to the non-conductive textile via the macromolecular template.

56. The method of claim 55, wherein step (a) comprises forming an aqueous solution of the macromolecular template and the polymer subunits, reducing the pH of the solution to a value between 1.1-2.4, and contacting the solution with an oxidant.

57. The method of claim 56, wherein the molar ratio of polymer subunits to oxidant is between 2:1 and 1:1.

58. The method of claim 55, wherein the molar ratio of macromolecular template to polymer subunits is between 1:1-1:4.

59. The method of claim 26, wherein:
the macromolecular template is selected from the group consisting of sulfonated polyanilines or derivatives thereof, sulfonated polystyrenes or derivatives thereof, dextran sulfate, calixarenes, cyclodextrins and derivatives thereof, synthetic tanning agents based upon sulfonated polycondensation products derived from aromatic sulfonic acids or sulfones and formaldehyde, synthetic tanning agents based upon polyacrylic-acid or salts or esters thereof, polypropylene oxide polyurethane shrinkproofing polymers containing reactive carbamoyl sulfonate groups, sulfonated polypyrroles or derivatives thereof, sulfonated polythiophenes or derivatives thereof, and copolymers or mixtures of any of the above; and
the conductive polymer is selected from the group consisting of polyaniline, polypyrrole, polythiophene, polyphenyl mercaptan polyindole, polycarbazole or derivatives or a copolymer or combination thereof.

60. An article formed partly or entirely from the electroconductive textile of claim 1.

61. An article formed partly or entirely from the electroconductive textile produced by the method of claim 26.

62. The article of claim 60, wherein the article is selected from gloves, car seats, heating panels for car seats, protective clothing, hosiery, apparel items, footwear, headgear, strange gauges, energy storage devices and energy conversion devices.
